(19) United States
(12) Patent Application Publication
(10) Pub. No.: US 2018/0281433 A1
(43) Pub. Date: Oct. 4, 2018

(54) LIQUID SUPPLY UNIT AND LIQUID JETTING DEVICE

(71) Applicant: Seiko Epson Corporation, Tokyo (JP)

(72) Inventors: Shun OYA, Kiso-machi (JP); Taku ISHIZAWA, Matsumoto-shi (JP); Atsushi KOBAYASHI, Matsumoto-shi (JP)

(73) Assignee: Seiko Epson Corporation, Tokyo (JP)

(21) Appl. No.: 15/778,544

(22) PCT Filed: Oct. 28, 2016
(86) PCT No.: PCT/JP2016/081978

§ 371 Date: May 23, 2018

(30) Foreign Application Priority Data
Nov. 27, 2015 (JP) 2015-231552

(51) Int. Cl. B41J 2/175

(52) U.S. Cl. CPC B41J 2/17523; B41J 2/17563; B41J 2/17553

(57) ABSTRACT

A liquid supply unit includes a first wall part to a seventh wall part. The first wall part includes a liquid supply part and an outer peripheral wall surrounding the liquid supply part and protruding in a direction from the second wall part toward the first wall part so as to come into contact with a sealing member of a carriage. The liquid supply part has a filter for supplying liquid to a liquid introduction part upon coming into contact with the liquid introduction part. A distance between the third wall part and the fourth wall part is larger than a distance between the fifth wall part and the sixth wall part. In a plan view in a direction from the first wall part toward the second wall part, a length of the outer peripheral wall in a first direction from the third wall part toward the fourth wall part is larger than a length in a second direction from the fifth wall part toward the sixth wall part. In a state of the liquid supply unit mounted on the carriage, the first direction is set along a moving direction of the carriage.

### FIELD

The present invention relates to a liquid supply unit and a liquid jetting device.

### BACKGROUND

A container for supplying ink to a printer has been widely used conventionally. The container disclosed in Patent Document 1 includes a liquid supply part for supplying ink to a printer. An annular protrusion (hereinafter, referred to as outer peripheral wall) is disposed around the liquid supply part. The printer includes a carriage on which the container is mounted, and the carriage includes a liquid introduction part for receiving supply of ink from the liquid supply part of the container. A sealing member is disposed around the liquid introduction part. When the container is mounted on the carriage, the outer peripheral wall comes into contact with the sealing member perpendicularly, and the liquid supply part is connected to the liquid introduction part, thereby supplying ink from the container to the printer.

### CITATION LIST

### Patent Literature

[Patent Document 1] JP2014-28500A

### SUMMARY

### Technical Problem

According to such a conventional technique, a frictional force generated between an outer peripheral wall and a sealing member enables to suppress displacement of connection between a liquid supply part and a liquid introduction part as a carriage moves. However, according to such a conventional technique, a sufficient frictional force is not secured in some cases. Therefore, a new technique has been desired, which allows satisfactory connection between a liquid supply part and a liquid introduction part by increasing a frictional force generated between an outer peripheral wall and a sealing member. Such a problem is common not only to printers and containers, but also to various types of liquid jetting devices capable of jetting liquid and various types of liquid supply units mountable on the liquid jetting devices.

### Solution to Problem

The present invention has been made to solve at least a part of the above-described problem, and is enabled to be realized as the following aspects.

(1) A first aspect of the present invention provides a liquid supply unit configured to be mounted on a carriage of a liquid jetting device so as to supply liquid to a liquid introduction part of the carriage. The liquid supply unit includes a first wall part, a second wall part opposed to the first wall part, a third wall part intersecting with the first wall part and the second wall part, a fourth wall part intersecting with the first wall part and the second wall part and being opposed to the third wall part, a fifth wall part intersecting with the first wall part, the second wall part, the third wall part and the fourth wall part, a sixth wall part intersecting with the first wall part, the second wall part, the third wall part and the fourth wall part and being opposed to the fifth wall part, and a seventh wall part intersecting with the fifth wall part and the sixth wall part and being positioned between the first wall part and the fourth wall part. The first wall part includes a liquid supply part and an outer peripheral wall surrounding the liquid supply part and protruding in a direction from the second wall part toward the first wall part so as to come into contact with a sealing member of the carriage. The liquid supply part has a filter for supplying the liquid to the liquid introduction part upon coming into contact with the liquid introduction part. A distance between the third wall part and the fourth wall part is larger than a distance between the fifth wall part and the sixth wall part. In a plan view in a direction from the first wall part toward the second wall part, a length L1 of the outer peripheral wall in a first direction from the third wall part toward the fourth wall part is larger than a length L2 in a second direction from the fifth wall part toward the sixth wall part. In a state of the liquid supply unit mounted on the carriage, the first direction is set along a moving direction of the carriage. According to such an aspect of the liquid supply unit, a larger frictional force of the outer peripheral wall is enabled to be generated against the sealing member, thereby enabling to suppress shifting between the liquid supply part and the liquid introduction part as the carriage moves. Accordingly, the liquid supply part and the liquid introduction part are enabled to be connected properly.

(2) In the liquid supply unit according to the above-described aspect, the third wall part may have a protrusion protruding in a direction from the fourth wall part toward the third wall part so as to be engaged with a dent part of the carriage. The liquid supply unit may be configured to be rotated centering on a portion of the protrusion coming into contact with the dent part of the carriage when the liquid supply unit is mounted on and detached from the carriage. In the plan view in the direction from the first wall part toward the second wall part, L1 represents the length of the outer peripheral wall in the first direction, L3 represents a distance from the third wall part to the fourth wall part, and L4 represents a distance from the first wall part to the fourth wall part, wherein

relation of L1×2>(L3−L4) may be satisfied. According to such an aspect, in the plan view in the direction from the first wall part toward the second wall part, the area occupied by the outer peripheral wall is enlarged in the area excluding the seventh wall part, thereby enabling to increase the frictional force.

(3) In the liquid supply unit according to the above-described aspect, the seventh wall part may have a contact part coming into contact with an electrode part of the liquid jetting device. According to such an aspect, in the plan view in the direction from the first wall part toward the second wall part, the area occupied by the outer peripheral wall is enlarged in the area excluding the seventh wall part having the contact part, thereby enabling to increase the frictional force.

(4) In the liquid supply unit according to the above-described aspect, in a state of the liquid supply unit being mounted on the carriage, H1 represents a distance from the bottom wall of the carriage to the second wall part in the direction from the first wall part toward the second wall part, while H2 represents a height from the bottom wall of the carriage, of an opposed part of wall parts of the carriage to the third wall part in the direction from the first wall part toward the second wall part, wherein

relation of H1>H2 may be satisfied. According to such an aspect, the carriage is suppressed from being enlarged in the moving direction of the carriage. A space in which the carriage is able to move is provided in the moving direction of the carriage, thereby enabling to suppress the risk that the liquid supply unit comes into contact with other structure even when the liquid supply unit rides over a wall part of the carriage during when the liquid supply unit is rotated to be mounted on and detached from the carriage.

(5) In the liquid supply unit according to the above-described aspect, in the state of the liquid supply unit being mounted on the carriage, H1 represents the distance from the bottom wall of the carriage to the second wall part in the direction from the first wall part toward the second wall part, while DH represents a difference between the distance H1 and a height from the bottom wall of the carriage, of the opposed part of the wall parts of the carriage to the third wall part in the direction from the first wall part toward the second wall part, wherein

relation of DH×2>(H1−DH) may be satisfied. According to such an aspect, the carriage is suppressed from being enlarged in the moving direction of the carriage. A space in which the carriage is able to move is provided in the moving direction of the carriage, thereby enabling to suppress the risk that the liquid supply unit comes into contact with other structure even when the liquid supply unit rides over a wall part of the carriage during when the liquid supply unit is rotated to be mounted on and detached from the carriage.

(6) In the liquid supply unit according to the above-described aspect, L5 represents a distance from the first wall part to the second wall part, while L3 represents a distance from the third wall part to the fourth wall part, wherein

relation of L5×1.5>L3 may be satisfied. According to such an aspect, the carriage is suppressed from being enlarged in the moving direction of the carriage.

(7) A second aspect of the present invention provides a liquid jetting device. The liquid jetting device includes a carriage and a liquid supply unit mounted on the carriage. The carriage includes a liquid introduction part, a sealing member surrounding the liquid introduction part, and a liquid jetting head communicating with the liquid introduction part. The liquid supply unit includes a liquid supply part coming into contact with the liquid introduction part, and an outer peripheral wall surrounding the liquid supply part and protruding in a direction of the liquid supply part coming into contact with the liquid introduction part so as to come into contact with the sealing member. The liquid supply part has a filter for supplying liquid to the liquid introduction part upon coming into contact with the liquid introduction part. A length of the liquid supply unit in a direction of the carriage moving is larger than a length of the liquid supply unit in a direction orthogonal to the direction of the carriage moving. A length of the outer peripheral wall in the direction of the carriage moving is larger than a length of the outer peripheral wall in the direction orthogonal to the direction of the carriage moving. According to such an aspect of the liquid jetting device, a larger frictional force of the outer peripheral wall is enabled to be generated against the sealing member, thereby enabling to suppress shifting between the liquid supply part and the liquid introduction part as the carriage moves. Accordingly, the liquid supply part and the liquid introduction part are enabled to be connected properly.

(8) In the liquid jetting device according to the above-described aspect, the carriage further may include a dent part, and the liquid supply unit may further include a protrusion to be engaged with the dent part. The liquid supply unit may be configured to be rotated centering on a portion of the protrusion coming into contact with the dent part of the carriage when the liquid supply unit is mounted on and detached from the carriage. A height of an end wall having the protrusion of wall parts of the liquid supply unit from a bottom wall of the carriage may be larger than a height of a side wall having the dent part of wall parts of the carriage from the bottom wall of the carriage. According to such an aspect, the carriage is suppressed from being enlarged in the moving direction of the carriage, thereby enabling to downsize the liquid jetting device. A space in which the carriage is able to move is provided in the moving direction of the carriage, thereby enabling to suppress the risk that the liquid supply unit comes into contact with other structure even when the liquid supply unit rides over a wall part of the carriage during when the liquid supply unit is rotated to be mounted on and detached from the carriage.

(9) In the liquid jetting device according to the above-described aspect, the carriage may further include a dent part, and the liquid supply unit may further include a protrusion to be engaged with the dent part. The liquid supply unit may be configured to be rotated centering on a portion of the protrusion coming into contact with the dent part of the carriage when the liquid supply unit is mounted on and detached from the carriage. A height of an end wall having the protrusion of wall parts of the liquid supply unit from a bottom wall of the carriage may be smaller than three times a difference between the height of the end wall having the protrusion of the wall parts of the liquid supply unit from the bottom wall of the carriage and a height of a side wall having the dent part of wall parts of the carriage from the bottom wall of the carriage. According to such an aspect, the carriage is suppressed from being enlarged in the moving direction of the carriage, thereby enabling to downsize the liquid jetting device. A space in which the carriage is able to move is provided in the moving direction of the carriage, thereby enabling to suppress the risk that the liquid supply unit comes into contact with other structure even when the liquid supply unit rides over a wall part of the carriage during when the liquid supply unit is rotated to be mounted on and detached from the carriage.

(10) A third aspect of the present invention provides a liquid jetting device. The liquid jetting device includes a carriage, a first liquid supply unit mounted on the carriage, and a second liquid supply unit mounted on the carriage. The carriage includes a first liquid introduction part, a second liquid introduction part, a first sealing member surrounding the first liquid introduction part, a second sealing member surrounding the second liquid introduction part, and a liquid jetting head communicating with the first liquid introduction part and the second liquid introduction part. The first liquid supply unit includes a first liquid supply part coming into contact with the first liquid introduction part, and a first outer peripheral wall surrounding the first liquid supply part and protruding in a direction of the first liquid supply part coming into contact with the first liquid introduction part so as to come into contact with the first sealing member. The second liquid supply unit includes a second liquid supply part coming into contact with the second liquid introduction part, and a second outer peripheral wall surrounding the second liquid supply part and protruding in a direction of the second liquid supply part coming into contact with the second liquid introduction part so as to come into contact with the second sealing member. The first liquid supply part has a first filter for supplying first liquid to the first liquid introduction part upon coming into contact with the first liquid introduction part. The second liquid supply part has a second filter for supplying second liquid to the second liquid introduction part upon coming into contact with the second liquid introduction part. A length of the first outer peripheral wall in a direction of the carriage moving is larger than a length of the first outer peripheral wall in a direction orthogonal to the direction of the carriage moving. A length of the second outer peripheral wall in the direction of the carriage moving is larger than a length of the second outer peripheral wall in the direction orthogonal to the direction of the carriage moving. The first liquid supply unit and the second liquid supply unit are aligned in the carriage in the direction orthogonal to the direction of the carriage moving. According to such an aspect of the liquid jetting device, a larger frictional force of the outer peripheral walls is enabled to be generated against the sealing members, thereby enabling to suppress shifting between the liquid supply parts and the liquid introduction parts as the carriage moves. Accordingly, the liquid supply parts and the liquid introduction parts are enabled to be connected properly.

(11) In the liquid jetting device according to the above-described aspect, the carriage further may include a first dent part and a second dent part. The first liquid supply unit may further include a first protrusion to be engaged with the first dent part. The second liquid supply unit may further include a second protrusion to be engaged with the second dent part. The first liquid supply unit may be configured to be rotated centering on a portion of the first protrusion coming into contact with the first dent part of the carriage when the first liquid supply unit is mounted on and detached from the carriage. The second liquid supply unit may be configured to be rotated centering on a portion of the second protrusion coming into contact with the second dent part of the carriage when the second liquid supply unit is mounted on and detached from the carriage. A height of an end wall having the first protrusion of wall parts of the first liquid supply unit from a bottom wall of the carriage may be larger than a height of a side wall having the first dent part of wall parts of the carriage from the bottom wall of the carriage. A height of an end wall having the second protrusion of wall parts of the second liquid supply unit from the bottom wall of the carriage may be larger than a height of a side wall having the second dent part of the wall parts of the carriage from the bottom wall of the carriage. According to such an aspect, the carriage is suppressed from being enlarged in the moving direction of the carriage, thereby enabling to downsize the liquid jetting device. A space in which the carriage is able to move is provided in the moving direction of the carriage, thereby enabling to suppress the risk that the liquid supply unit comes into contact with other structure even when each of the liquid supply units rides over a wall part of the carriage during when each of the liquid supply units is rotated to be mounted on and detached from the carriage.

(12) A fourth aspect of the present invention provides a liquid jetting device. The liquid jetting device includes a carriage equipped with a first liquid supply unit and a second liquid supply unit. The carriage includes a first liquid introduction part, a second liquid introduction part, a first sealing member surrounding the first liquid introduction part, a second sealing member surrounding the second liquid introduction part, and a liquid jetting head communicating with the first liquid introduction part and the second liquid introduction part. The first liquid supply unit includes a first liquid supply part coming into contact with the first liquid introduction part, and a first outer peripheral wall surrounding the first liquid supply part and protruding in a direction of the first liquid supply part coming into contact with the first liquid introduction part so as to come into contact with the first sealing member. The second liquid supply unit includes a second liquid supply part coming into contact with the second liquid introduction part, and a second outer peripheral wall surrounding the second liquid supply part and protruding in a direction of the second liquid supply part coming into contact with the second liquid introduction part so as to come into contact with the second sealing member. The first liquid supply part has a first filter for supplying first liquid to the first liquid introduction part upon coming into contact with the first liquid introduction part. The second liquid supply part has a second filter for supplying second liquid to the second liquid introduction part upon coming into contact with the second liquid introduction part. A length of the first outer peripheral wall in a direction of the carriage moving is larger than a length of the first outer peripheral wall in a direction orthogonal to the direction of the carriage moving. A length of the second outer peripheral wall in the direction of the carriage moving is larger than a length of the second outer peripheral wall in the direction orthogonal to the direction of the carriage moving. The first liquid supply unit and the second liquid supply unit are aligned in the carriage in the direction orthogonal to the direction of the carriage moving. According to such an aspect of the liquid jetting device, a larger frictional force of the outer peripheral walls is enabled to be generated against the sealing members, thereby enabling to suppress shifting between the liquid supply parts and the liquid introduction parts as the carriage moves. Accordingly, the liquid supply parts and the liquid introduction parts are enabled to be connected properly.

The present invention is enabled to be realized in various aspects other than the aspects of the above-described liquid supply units and liquid jetting devices. The present invention is enabled to be realized in the aspects of, for example, a liquid supply system, a cartridge, and a printing apparatus.

### BRIEF DESCRIPTION OF DRAWINGS

FIG. 1 is a perspective view illustrating a schematic configuration of a liquid supply system.

FIG. 2 is a first perspective view of a holder.

FIG. 3 is a second perspective view of the holder.

FIG. 4 is a plan view of the holder as viewed from a +Z-axis direction side.

FIG. 5 is a first external perspective view of a cartridge.

FIG. 6 is a second external perspective view of the cartridge.

FIG. 7 is a front view of the cartridge.

FIG. 8 is a rear view of the cartridge.

FIG. 9 is a left side view of the cartridge.

FIG. 10 is a right side view of the cartridge.

FIG. 11 is a plan view of the cartridge.

FIG. 12 is a bottom view of the cartridge.

FIG. 13 illustrates how the cartridge is mounted in and detached from the holder.

FIG. 14 is a cross sectional view illustrating a structure of a liquid supply part.

FIG. 15 is a schematic diagram for explaining the internal structure of the cartridge.

FIG. 16 is another schematic diagram for explaining the internal structure of the cartridge.

FIG. 17 is another schematic diagram for explaining the internal structure of the cartridge.

FIG. 18 is an exploded perspective view of the cartridge.

FIG. 19 is an XZ cross sectional view of the cartridge and a carriage in a mounted state.

FIG. 20 is a schematic diagram illustrating a configuration of a liquid supply unit according to a second embodiment.

FIG. 21 is a schematic diagram illustrating a configuration of a liquid supply unit according to a third embodiment.

### DESCRIPTION OF EMBODIMENTS

### A. Embodiment

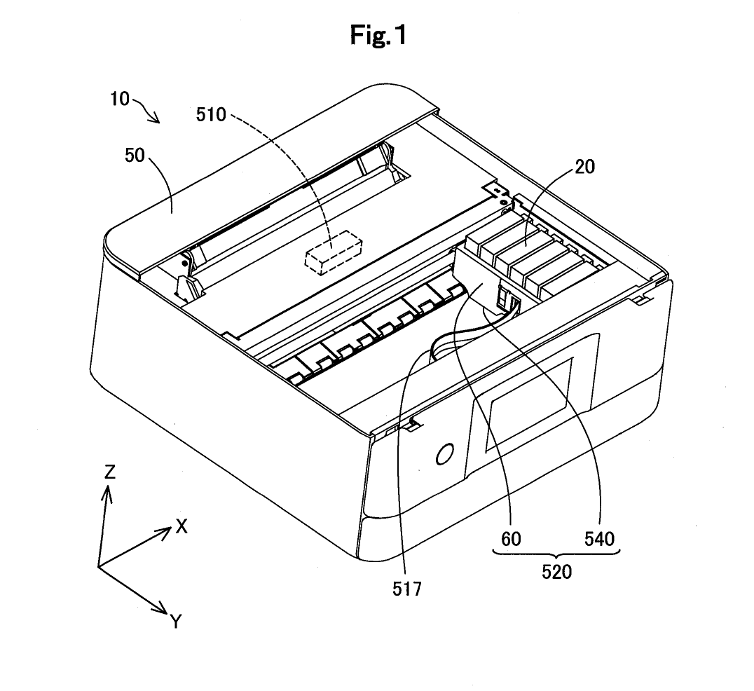

FIG. 1 is a perspective view illustrating a schematic configuration of a liquid supply system 10. FIG. 1 illustrates mutually orthogonal X, Y and Z axes. The X, Y and Z axes in FIG. 1 correspond to the X, Y and Z axes in other figures. The liquid supply system 10 includes a cartridge 20 serving as a liquid supply unit and a printer 50 serving as a liquid jetting device. In the liquid supply system 10, the cartridge 20 is able to be mounted on a carriage 520 of the printer 50 by a user.

The cartridge 20 of the liquid supply system 10 contains ink serving as printing material (liquid). The ink contained in the cartridge 20 is supplied to a liquid jetting head 540 through a liquid supply part and a liquid introduction part, which will be described below. In the present embodiment, the plurality of cartridges 20 are detachably mounted in a holder 60 of the printer 50. In the present embodiment, six types of cartridges 20 are disposed so as to correspond to inks in six colors (black, yellow, magenta, light magenta, cyan and light cyan) respectively, that is, the six cartridges 20 in total are mounted in the holder 60. Any two of the plurality of cartridges 20 correspond to a “first liquid supply unit” and a “second liquid supply unit,” respectively.

In another embodiment, the number of cartridges to be mounted in the holder 60 may be six or less, or may be six or more. In another embodiment, the types of ink colors of the cartridges 20 may be six or less, or may be six or more. In another embodiment, two or more of the cartridges 20 corresponding to one ink color may be mounted in the holder 60. The configurations of the cartridge 20 and the holder 60 will be detailed below.

The printer 50 is a small-size ink jet printer for an individual user. The printer 50 includes, in addition to the holder 60, a control part 510 and the carriage 520 having the holder 60. The carriage 520 includes the liquid jetting head 540. The printer 50 circulates ink from the cartridge 20 mounted in the holder 60 to the liquid jetting head 540 through the liquid introduction part to be described below, and ejects (supplies) ink from the liquid jetting head 540 onto a printing medium such as paper or a label. In such a manner, characters, graphics, images and the like are printed on the printing medium by use of the liquid jetting head 540.

The control part 510 of the printer 50 controls each part of the printer 50. The carriage 520 of the printer 50 is configured to move the liquid jetting head 540 relatively to the printing medium. The liquid jetting head 540 of the printer 50 includes an ink ejecting mechanism for ejecting the ink contained in the cartridge 20 onto the printing medium. The control part 510 and the carriage 520 are electrically connected via a flexible cable 517, and the ink ejecting mechanism of the liquid jetting head 540 operates on the basis of a control signal from the control part 510.

In the present embodiment, the carriage 520 is configured to include the holder 60 together with the liquid jetting head 540. As described above, the cartridge 20 is mounted in the holder 60 on the carriage 520 for moving the liquid jetting head 540, and such a type of the printer 50 is also called “on-carriage type.” In another embodiment, the holder 60 which is immovable may be configured at a portion separated from the carriage 520, so that the ink from the cartridge 20 mounted in the holder 60 is supplied to the liquid jetting head 540 of the carriage 520 through the flexible tube. Such a type of a printer is also called “off-carriage type.”

In the present embodiment, the printer 50 includes a main scanning feed mechanism and a sub scanning feed mechanism for moving the carriage 520 and the printing medium relatively to each other to realize printing onto the printing medium. The main scanning feed mechanism of the printer 50, which includes a carriage motor and a driving belt, transmits the power of the carriage motor to the carriage 520 via the driving belt, thereby reciprocating the carriage 520 in a main scanning direction. The sub scanning feed mechanism of the printer 50, which includes a conveying motor and a platen, transmits the power of the conveying motor to the platen, thereby conveying the printing medium in the sub scanning direction orthogonal to the main scanning direction. Each of the carriage motor of the main scanning feed mechanism and the conveying motor of the sub scanning feed mechanism operates on the basis of a control signal from the control part 510.

In the present embodiment, in a use state (also referred to as “using posture”) of the liquid supply system 10, a Y axis represents the axis along the sub scanning direction (front-rear direction) in which the printing medium is conveyed; an X axis represents the axis along the main scanning direction (right-left direction) in which the carriage 520 reciprocates; and a Z axis represents the axis along the gravitational direction (vertical direction). The use state of the liquid supply system 10 is the state in which the liquid supply system 10 is disposed on a horizontal plane. In the present embodiment, the horizontal plane is a plane parallel to the X axis and the Y axis (XY plane).

In the present embodiment, the sub scanning direction (front direction) corresponds to +Y-axis direction; the opposite direction thereof (rear direction) corresponds to −Y-axis direction; the direction from the lower side to the upper side along the gravitational direction (upward direction) corresponds to +Z-axis direction; and the opposite direction thereof (downward direction) corresponds to −Z-axis direction. In the present embodiment, the +Y-axis direction side (front side) corresponds to the front face of the liquid supply system 10. In the present embodiment, the +X-axis direction (right direction) corresponds to the direction from the left side surface toward the right side surface of the liquid supply system 10, and the −X-axis direction (left direction) corresponds to the opposite direction thereof. The direction along the X axis (right-left direction) is also referred to as “X-axis direction,” while the direction along the Z axis (vertical direction) is also referred to as “Z-axis direction.”

In the present embodiment, the aligning direction of the plurality of cartridges 20 mounted in the holder 60 corresponds to the Y-axis direction. That is, in the carriage 520, the plurality of cartridges 20 are aligned in the direction (Y-axis direction) orthogonal to the direction in which the carriage 520 moves (X-axis direction).

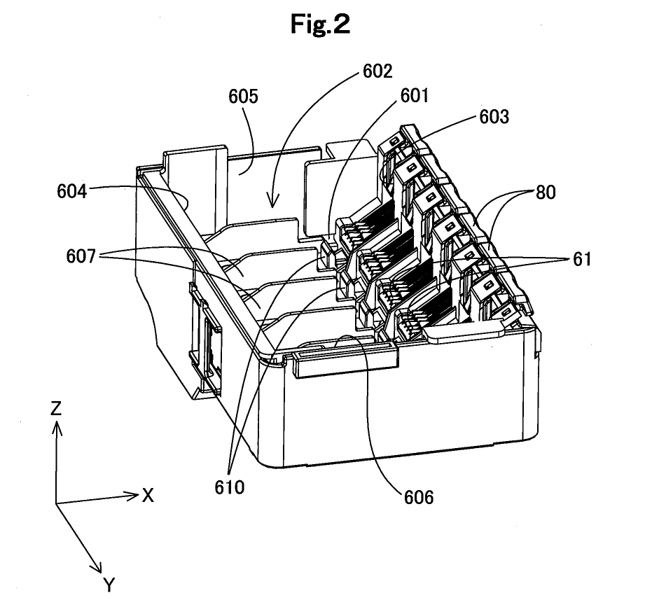

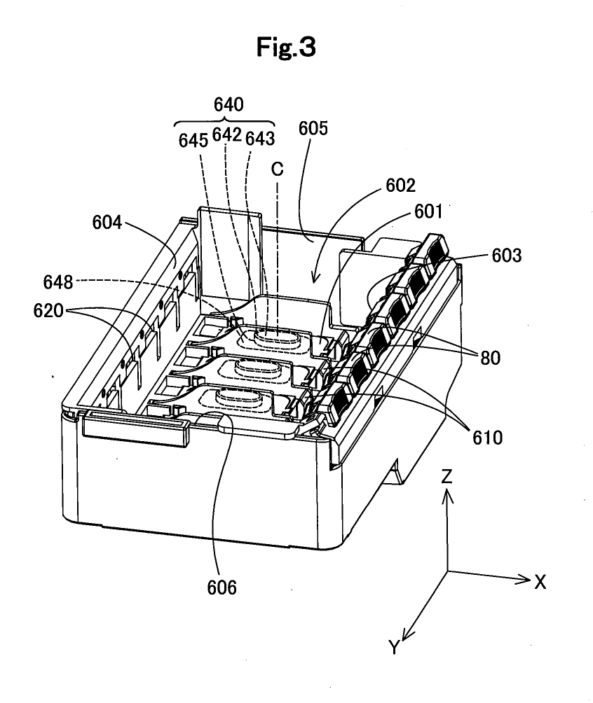

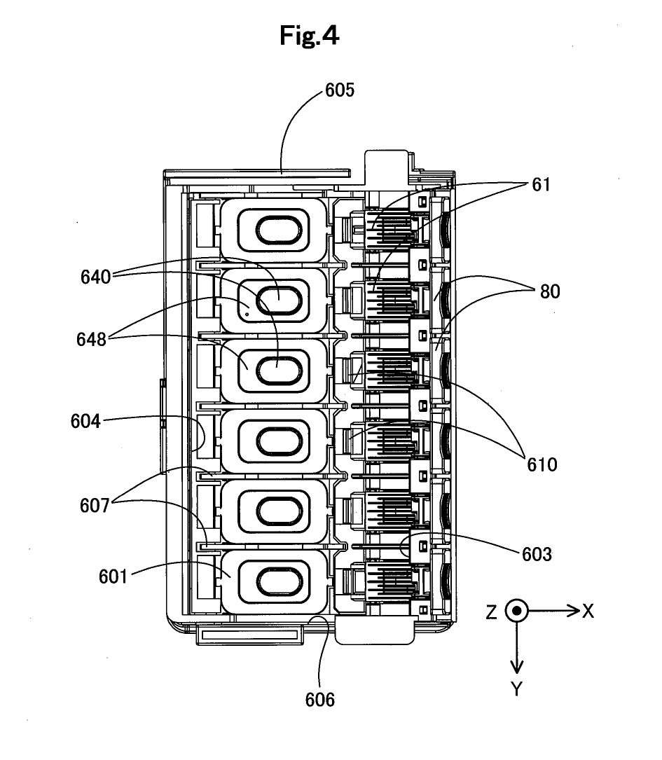

FIG. 2 is a first perspective view of the holder 60. FIG. 3 is a second perspective view of the holder 60. FIG. 4 is a plan view of the holder 60 as viewed from the +Z-axis direction side.

As shown in FIG. 2 to FIG. 4, the holder 60 has five wall parts 601, 603, 604, 605, and 606. The recess formed by these five wall parts serves as a cartridge housing chamber 602 (also referred to as “cartridge mounting part 602”). Hereinafter, the wall part 601 is also referred to as the bottom wall 601. The cartridge housing chamber 602 is divided by partition walls 607 into a plurality of slots (mounting spaces) each of which is able to receive each of the cartridges 20. Each of the partition walls 607 functions as a guide when the cartridge 20 is inserted into each slot. Each slot includes a liquid introduction part 640, a sealing member 648, an electrode part 61, a lever 80, a positioning protrusion 610, and a device-side regulating part 620 (FIG. 3). One side surface (surface in the +Z-axis direction side: upper surface) of each slot is opened. The cartridge 20 is mounted in and detached from the holder 60 through the opened one side surface (upper surface). The liquid introduction part 640 is configured so as to be interposed between two of the partition walls 607.

The positioning protrusion 610 is a substantially rectangular parallelepiped member protruding from the bottom wall 601 toward the +Z-axis direction. The positioning protrusion 610 is inserted into a positioning part disposed in the cartridge 20. In order to facilitate insertion into the positioning part of the cartridge 20, the positioning protrusion 610 has such a shape that the surface in the +X-axis direction side and the surface in the −X-axis direction side of the tip part are inclined so as to approach each other toward the tip.

The cartridge 20 is mounted in the holder 60, in such a manner that the cartridge 20 is locked by the lever 80 and the device-side regulating part 620 and the liquid supply part described below is connected to the liquid introduction part 640. This state is referred to as “a state in which the cartridge 20 is mounted in the holder 60” or also as “mounted state.” In the mounted state, a group of terminals disposed on a circuit board described below of the cartridge 20 is electrically connected to the electrode part 61, whereby various types of information are transmitted between the cartridge 20 and the printer 50.

The liquid introduction part 640 in the mounted state is connected to the liquid supply part of the cartridge 20, thereby allowing the ink contained in the cartridge 20 to flow to the liquid jetting head 540 communicating with the liquid introduction part 640. The liquid introduction part 640, which is formed in a substantially cylindrical shape, has a tip part 642 positioned in the +Z axis side and a base end part 645 positioned in the −Z axis side. The base end part 645 is disposed on the bottom wall 601. The tip part 642 is to be connected to the liquid supply part of the cartridge 20. The tip part 642 is equipped with a device-side filter 643. Ink flows into the liquid introduction part 640 from the liquid supply part of the cartridge 20 through the device-side filter 643. The device-side filter 643 is formed with a porous member, for example, a metal mesh, a metal nonwoven fabric, a resin filter or the like. A central axis C of the liquid introduction part 640 is parallel to the Z axis. The +Z-axis direction corresponds to the direction along the central axis C from the base end part 645 toward the tip part 642.

As shown in FIG. 3 and FIG. 4, the sealing member 648 surrounding the liquid introduction part 640 is disposed around the base end part 645 of the liquid introduction part 640. The sealing member 648 is formed of, for example, elastic rubber. The sealing member 648 seals the periphery of the liquid supply part of the cartridge 20 in the mounted state. Thus, the sealing member 648 prevents the ink from leaking from the liquid supply part to the periphery. In the mounted state, the sealing member 648 applies an energizing force including a component in the +Z-axis direction to the cartridge 20.

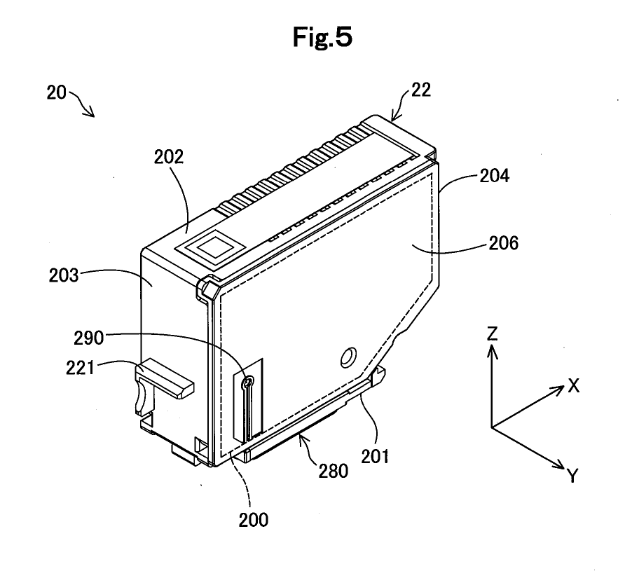

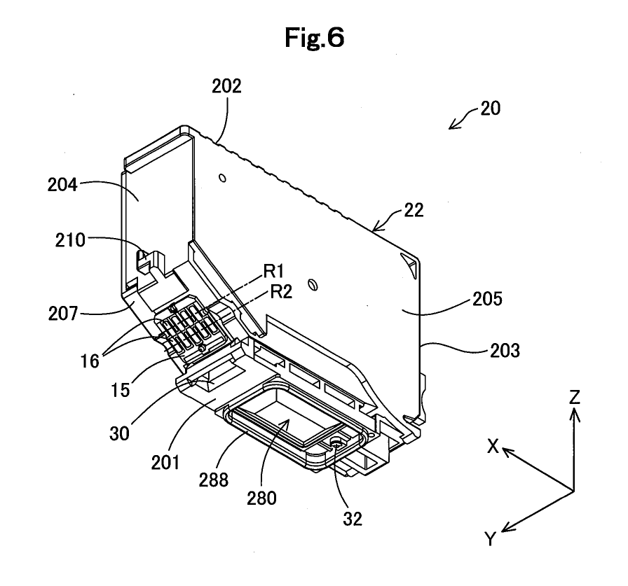

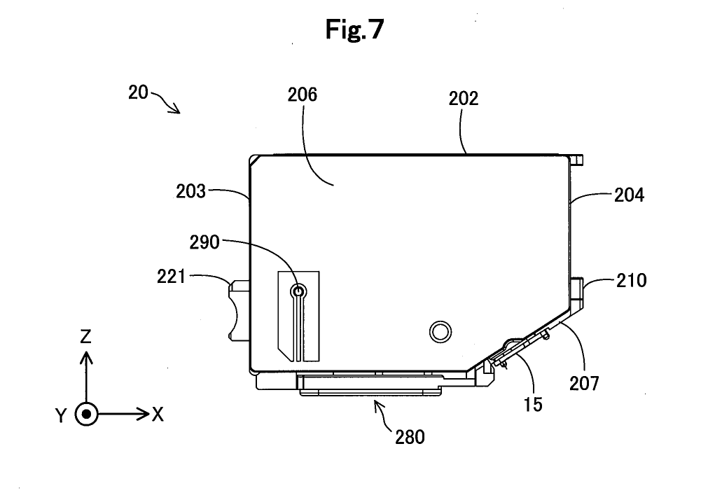

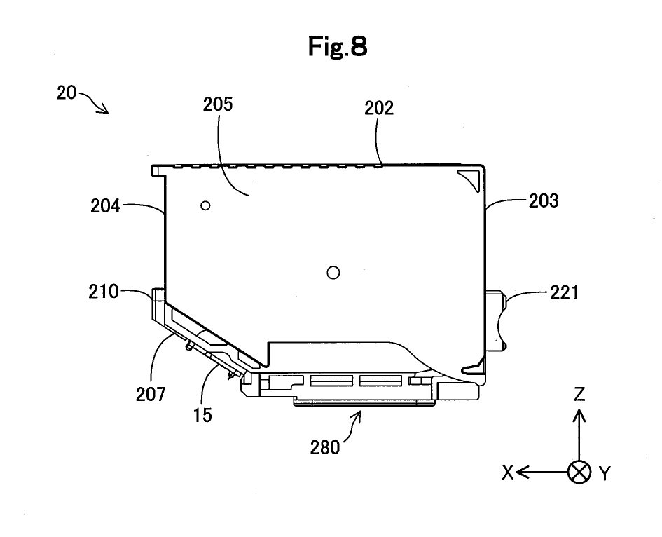

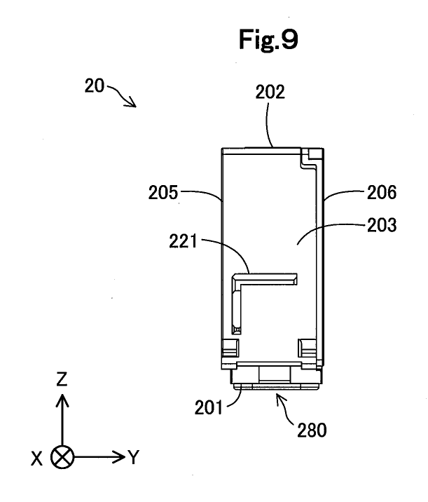

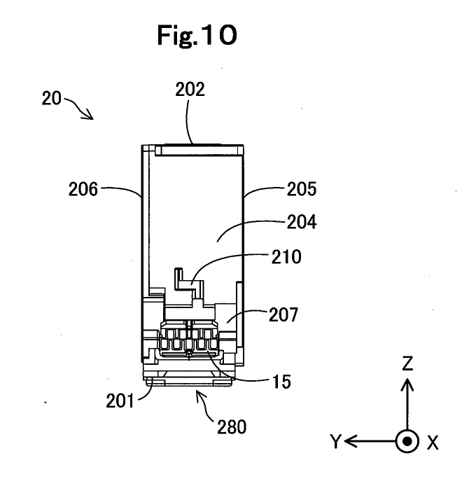

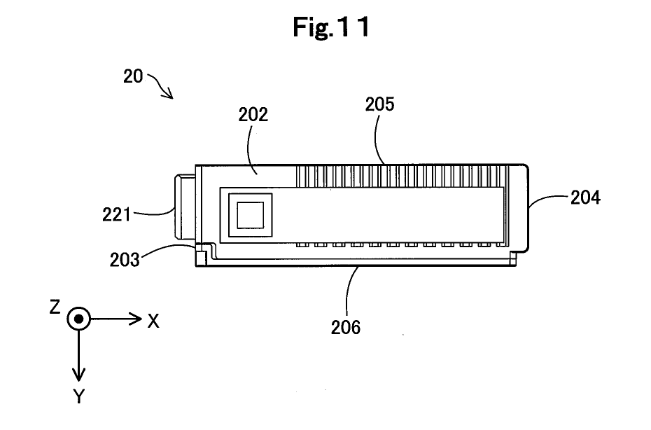

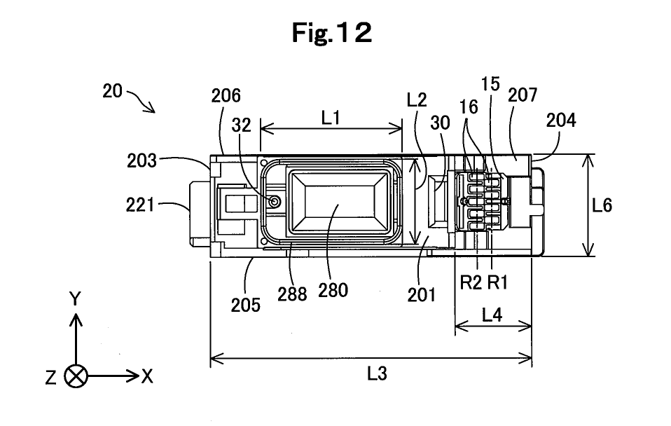

FIG. 5 is a first external perspective view of the cartridge 20. FIG. 6 is a second external perspective view of the cartridge 20. FIG. 7 is a front view of the cartridge 20. FIG. 8 is a rear view of the cartridge 20. FIG. 9 is a left side view of the cartridge 20. FIG. 10 is a right side view of the cartridge 20. FIG. 11 is a plan view of the cartridge 20. FIG. 12 is a bottom view of the cartridge 20. The cartridge 20 of the present embodiment is a so-called semi-sealed type cartridge, which introduces outside air into a liquid container 200 intermittently as the ink is consumed.

As shown in FIG. 5 and FIG. 6, the cartridge 20 has seven wall parts 201 to 207. These wall parts compose an enclosure 22 of the cartridge 20 having a substantially rectangular parallelepiped shape. The seven wall parts include a first wall part 201 (bottom wall 201), a second wall part 202 (upper wall 202), a third wall part 203 (one end wall 203), a fourth wall part 204 (other end wall 204), a fifth wall part 205 (one side wall 205), a sixth wall part 206 (other side wall 206), and a seventh wall part 207 (inclined wall 207). These seven wall parts 201 to 207 surround the liquid container 200 communicating with a liquid supply part 280.

In the following description, the state of two wall parts “intersecting” or “crossing” corresponds to one of the state in which two wall parts intersect with each other in a connected state, the state in which, if one wall part is extended, the one wall part may intersect with the other wall part, and the state in which, if two wall parts are extended, the wall parts may intersect with each other. The state of two wall parts “being opposed to” includes the both of the case in which no other object exists between the two wall parts and the case in which an object exists between the two wall parts.

Each of the outer surfaces of the wall parts 201 to 207 is substantially flat. The term “substantially flat” includes the case in which the targeted entire surface is completely flat and the case in which the targeted surface partially has dents and protrusions. That is, the term includes the case in which even if there are some dents and protrusions on a part of the surface, the targeted surface or wall composing the enclosure 22 of the cartridge 20 is able to be grasped. Each of the outer shapes of the first wall part 201 to the seventh wall part 207 in plan views is a rectangular, excluding the fifth wall part 205 and the sixth wall part 206. In the present embodiment, each of the first wall part 201 to the seventh wall part 207 may be an outer surface of an assembly in which a plurality of members are assembled. In the present embodiment, each of the first wall part 201 to the seventh wall part 207 has a plate shape. In another embodiment, some of the first wall part 201 to the seventh wall part 207 may be a film-like (thin film) member. Each of the first wall part 201 to the seventh wall part 207 is formed of, for example, a synthetic resin such as polyacetal (POM).

As shown in FIG. 5 and FIG. 6, each of the first wall part 201 and the second wall part 202 is a wall part parallel to the X axis and the Y axis. The second wall part 202 is opposed to the first wall part 201. That is, the first wall part 201 and the second wall part 202 are opposed to each other in the Z-axis direction. The first wall part 201 is positioned in the −Z-axis direction side, while the second wall part 202 is positioned in the +Z-axis direction side. Each of the first wall part 201 and the second wall part 202 is positioned so as to intersect with the third wall part 203, the fourth wall part 204, the fifth wall part 205, and the sixth wall part 206. In the present embodiment, the first wall part 201 corresponds to the bottom surface of the cartridge 20, and the second wall part 202 corresponds to the upper surface of the cartridge 20, in the mounted state in which the cartridge 20 is mounted in the holder 60. The first wall part 201 includes the liquid supply part 280, an outer peripheral wall 288 and a positioning part 30 so as to face toward the −Z-axis direction.

Each of the third wall part 203 and the fourth wall part 204 is a wall part parallel to the Y axis and the Z axis. The third wall part 203 and the fourth wall part 204 are opposed to each other in the X-axis direction. The third wall part 203 is positioned in the −X-axis direction side, and the fourth wall part 204 is positioned in the +X-axis direction side. The third wall part 203 intersects with the first wall part 201 and the second wall part 202. The fourth wall part 204 intersects with the first wall part 201 and the second wall part 202, and is opposed to the third wall part 203. In the present embodiment, in the state in which the cartridge 20 is mounted on the carriage 520, the carriage 520 moves along the direction from the third wall part 203 toward the fourth wall part 204.

Each of the fifth wall part 205 and the sixth wall part 206 is a wall part parallel to the X axis and the Z axis. The fifth wall part 205 and the sixth wall part 206 are opposed to each other in the Y-axis direction. The fifth wall part 205 intersects with the first wall part 201, the second wall part 202, the third wall part 203 and the fourth wall part 204. The sixth wall part 206 intersects with the first wall part 201, the second wall part 202, the third wall part 203 and the fourth wall part 204, and is opposed to the fifth wall part 205. As shown in FIG. 5, the sixth wall part 206 has a ventilation port 290 for introducing air into the cartridge 20.

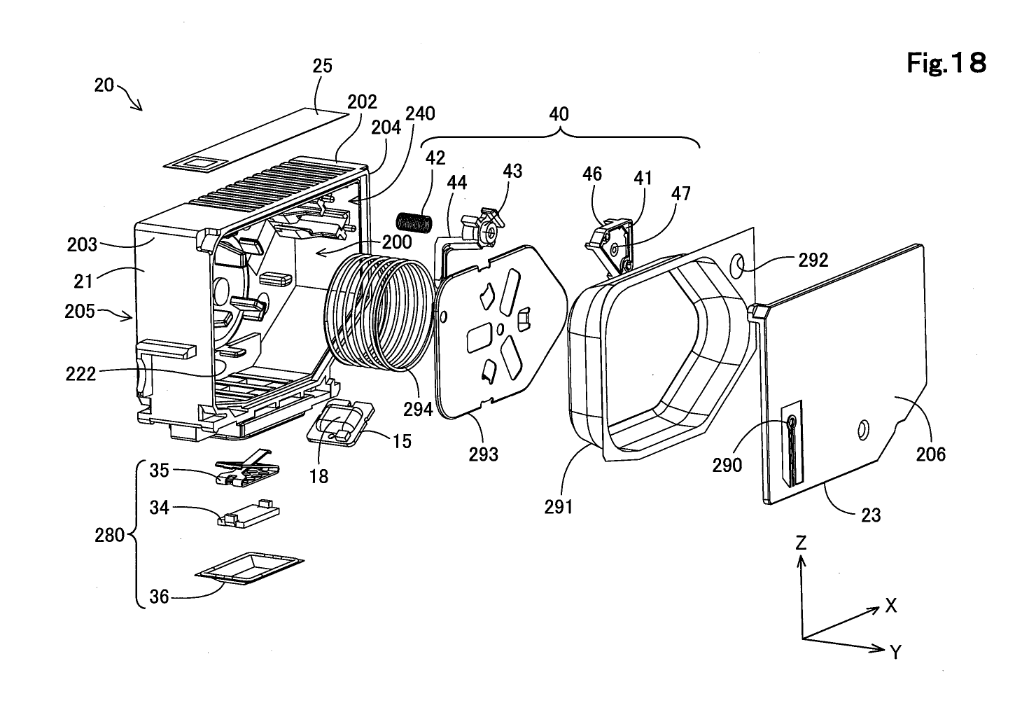

As shown in FIG. 6, the seventh wall part 207 is a wall part connecting the first wall part 201 and the fourth wall part 204. The seventh wall part 207 intersects with the fifth wall part 205 and the sixth wall part 206, and is positioned between the first wall part 201 and the fourth wall part 204. The seventh wall part 207 has a contact part 16 contactable with the electrode part 61 of the printer 50. In the present embodiment, the contact part 16 is formed on a substrate 15 disposed on the seventh wall part 207. That is, the substrate 15 has a plurality of the contact parts 16 coming into contact with the electrode part 61 disposed in the holder 60 in the mounted state. More specifically, each of the contact parts 16 is an area including some of the electrode terminals disposed on the surface of the substrate 15, coming into contact with the electrode part 61. In the present embodiment, the plurality of contact parts 16 form a first row R1 and a second row R2 with a predetermined interval in the X-axis direction as viewed from the −Z-axis direction. A memory device 18 (FIG. 18) for storing various types of information of the cartridge 20 is disposed on the back side of the substrate 15. The memory device 18 stores, for example, information indicating the state of residual ink and the colors of ink. When the electrode part 61 disposed in the holder 60 comes into contact with the contact parts 16, the control part 510 included in the printer 50 is capable of reading various types of information from the memory device 18 included in the cartridge 20, via the flexible cable 517.

As shown in FIG. 6, the first wall part 201 includes the positioning part 30 dented toward the +Z-axis direction at the end portion in the side of the seventh wall part 207. That is, the positioning part 30 is disposed between the liquid supply part 280 disposed on the first wall part 201 and the substrate 15 disposed on the seventh wall part 207. In the mounted state, the positioning protrusion 610 disposed in the holder 60 is inserted into and comes into contact with the positioning part 30. As a result, the cartridge 20 is positioned in the holder 60.

As shown in FIG. 6 and FIG. 10, the fourth wall part 204 has a first cartridge-side regulating part 210 (one rib 210) having a protruding shape. The first cartridge-side regulating part 210 is locked by the lever 80 in the mounted state. As shown in FIG. 5 and FIG. 9, the third wall part 203 has a second cartridge-side regulating part 221 (other rib 221) having a protruding shape. The second cartridge-side regulating part 221 is a protrusion which protrudes in the direction from the fourth wall part 204 toward the third wall part 203 and is able to be engaged with the device-side regulating part 620 of the carriage 520. In the mounted state, the second cartridge-side regulating part 221 is inserted into and locked by the device-side regulating part 620 which is a hole formed on the side wall 604 (FIG. 3) out of the wall parts of the holder 60. That is, in the mounted state, the cartridge 20 is locked in both sides of the X-axis direction by the lever 80 of the holder 60 and the device-side regulating part 620, whereby the cartridge 20 is fixed to the holder 60. In the following description, the second cartridge-side regulating part 221 is also referred to as “protrusion 221,” while the device-side regulating part 620 is also referred to as “dent part 620.”

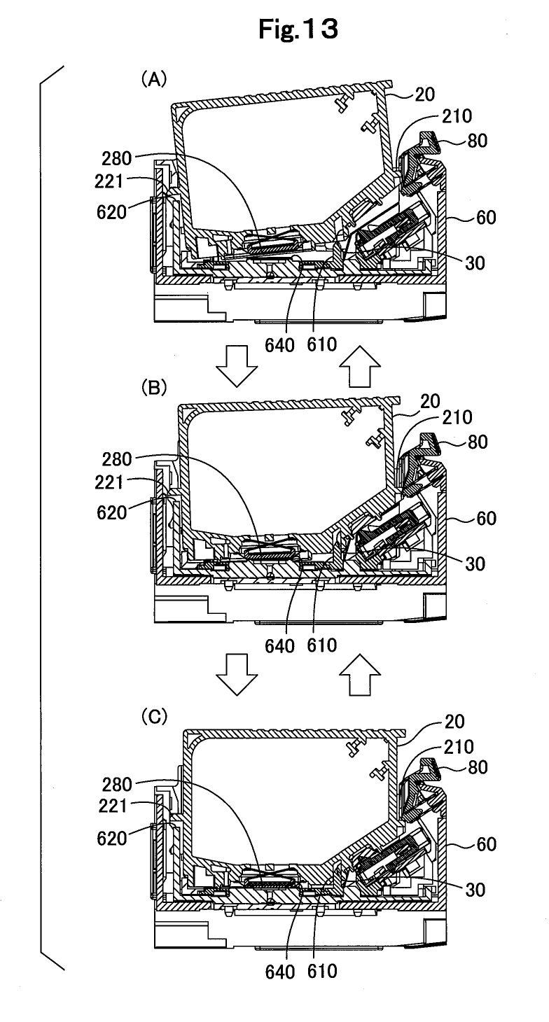

FIG. 13 illustrates how the cartridge 20 is mounted in and detached from the holder 60. In order that the cartridge 20 is mounted in the holder 60, first, as shown in FIG. 13(A), the protrusion 221 is inserted into the dent part 620, and the cartridge 20 is rotated (turned) centering on the portion where the device-side regulating part 620 and the protrusion 221 are in contact with each other. Then, as shown in FIG. 13(B), the positioning protrusion 610 is inserted into the positioning part 30, and further the liquid supply part 280 and the liquid introduction part 640 come into contact with each other. Lastly as shown in FIG. 13(C), the first cartridge-side regulating part 210 is locked by the lever 80, whereby the cartridge 20 is fixed in the holder 60. Conversely, in order that the cartridge 20 is detached from the holder 60, locking of the first cartridge-side regulating part 210 by the lever 80 is first released, and the cartridge 20 is rotated (turned) centering on the portion where the dent part 620 and the protrusion 221 are in contact with each other. As a result, the contact between the liquid supply part 280 and the liquid introduction part 640 is released, and the positioning protrusion 610 is pulled out from the positioning part 30, whereby the cartridge 20 is detached from the holder 60.

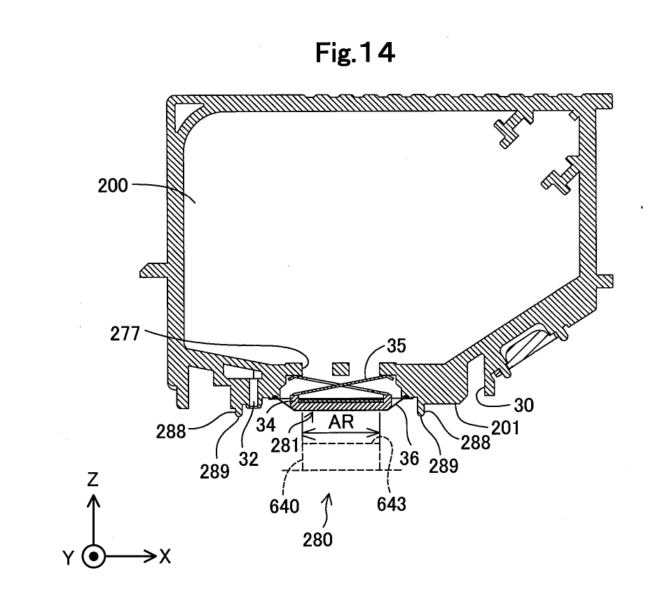

FIG. 14 is a cross sectional view illustrating the structure of the liquid supply part 280. The liquid supply part 280 includes a cartridge-side filter 36 which is capable of supplying ink to the liquid introduction part 640 upon coming into contact with the liquid introduction part 640. The liquid supply part 280 includes a liquid supply port 281 and an opening 277. The cartridge-side filter 36 covers the opening 277 from the outer surface side of the first wall part 201. In the present embodiment, the liquid supply part 280 further includes a foam 34 and a plate spring 35.

The liquid supply part 280 communicates with the liquid container 200 through the opening 277. The opening 277 is a hole going through the first wall part 201 along the Z-axis direction. The cartridge-side filter 36 is disposed on the −Z-axis direction side of the opening 277. The cartridge-side filter 36 is welded to the first wall part 201 around the opening 277. The cartridge-side filter 36 is formed of, for example, woven fabric, nonwoven fabric, or foamable resin (foam). Between the opening 277 and the cartridge-side filter 36, the plate spring 35 made of metal is disposed in the side of the opening 277, and the foam 34 is disposed in the side of the cartridge-side filter 36.

In order that the cartridge 20 is mounted in the holder 60, the plate spring 35 brings the cartridge-side filter 36 into indirect contact with the device-side filter 643 via the foam 34, while pressing the foam 34. The plate spring 35 is formed in such a shape that ink is not hindered from flowing from the opening 277 to the foam 34.

The foam 34 is a porous member disposed between the plate spring 35 and the cartridge-side filter 36. The foam 34 diffuses in and supplies to the cartridge-side filter 36 the ink supplied from the inside of the liquid container 200 through the opening 277. The foam 34 is formed of a synthetic resin, for example, polyethylene terephthalate.

The liquid supply port 281 is an area through which the ink in the liquid container 200 flows to the outside of the cartridge 20. Specifically, in the present embodiment, the liquid supply port 281 corresponds to, not to the entire area of the cartridge-side filter 36, an area AR of the cartridge-side filter 36, in which the ink flows out upon contacting with the device-side filter 643 disposed on the liquid introduction part 640 of the holder 60.

As shown in FIG. 6, FIG. 12 and FIG. 14, the first wall part 201 has the outer peripheral wall 288 which surrounds the liquid supply part 280 and protrudes in the direction from the second wall part 202 toward the first wall part 201, in other words, the direction in which the liquid supply part 280 comes into contact with the liquid introduction part 640, so as to be able to come into contact with the sealing member 648 of the carriage 520. The outer peripheral wall 288 protrudes longer than the liquid supply part 280 in the −Z-axis direction. In the mounted state, an end part 289 in the −Z-axis direction of the outer peripheral wall 288 comes into contact with the sealing member 648 disposed on the bottom wall 601 of the holder 60. As the carriage 520 moves, such contacting generates a frictional force between the outer peripheral wall 288 and the sealing member 648, thereby suppressing shifting in connection between the liquid supply part 280 and the liquid introduction part 640. When the outer peripheral wall 288 and the sealing member 648 come into contact with each other, the space in the outer peripheral wall 288 is substantially closed. Hereinafter, the space is also referred to as “closed space.”

A communication port 32 is formed between the outer peripheral wall 288 and the liquid supply part 280 on the first wall part 201. The communication port 32 is an opening for connecting the closed space in the outer peripheral wall 288 and the outside. In the mounted state, the communication port 32 connects the closed space in the outer peripheral wall 288 and the outside (outside air), thereby keeping the pressure difference between the closed space and the outside substantially constant. This suppresses the ink from leaking from the liquid supply part 280 due to pressure fluctuation in the closed space.

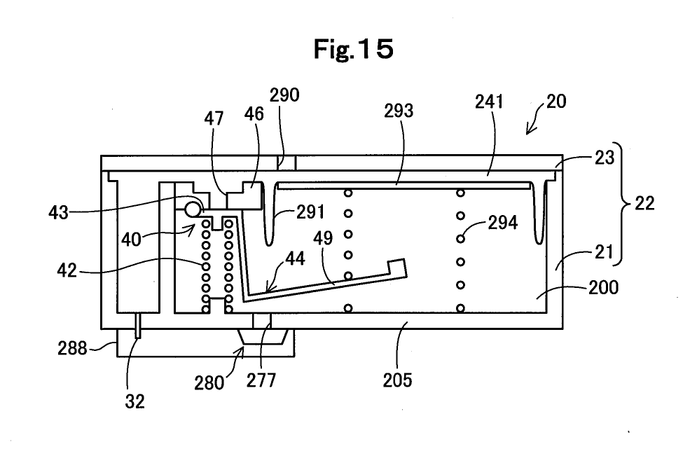

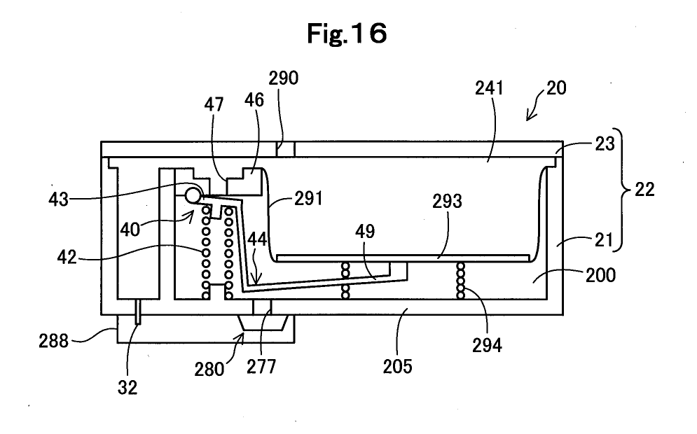

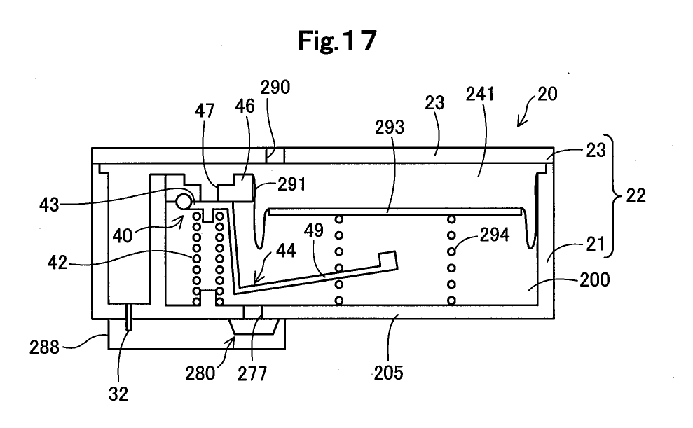

Each of FIG. 15, FIG. 16, and FIG. 17 is a schematic diagram for explaining the internal structure of the cartridge 20. As shown in FIG. 15, the enclosure 22 of the cartridge 20 has a body member 21 and a lid member 23. The body member 21 includes the first wall part 201, the second wall part 202, the third wall part 203, the fourth wall part 204, the fifth wall part 205, and the seventh wall part 207. The lid member 23 includes the sixth wall part 206. The lid member 23 is attached to close the opening of the body member 21, thereby forming the internal space in the cartridge 20. The body member 21 has the communication port 32. The lid member 23 has the ventilation port 290. Each of the communication port 32 and the ventilation port 290 communicates with the air. A sheet member 291 serving as a flexible member is positioned between the fifth wall part 205 and the sixth wall part 206 (lid member 23).

The cartridge 20 includes the liquid container 200. The liquid container 200 is partitioned by the body member 21 and the sheet member 291. That is, ink is contained between the fifth wall part 205 of the body member 21 and the sheet member 291. The liquid container 200 communicates with the liquid supply part 280 through the opening 277. The cartridge 20 includes an air chamber 241. The air chamber 241 is a space formed between the lid member 23 and the sheet member 291. The air chamber 241 communicates with the outside air through the ventilation port 290 disposed in the lid member 23. The communication port 32 communicates with the air chamber 241.

A pressure receiving plate 293 serving as a plate member is disposed in the liquid container 200. One surface of the pressure receiving plate 293 comes into contact with the surface of the sheet member 291 in the side of the liquid container 200. A coil spring 294 serving as an energizing member is disposed between the other surface (the surface in the −Y-axis direction side) of the pressure receiving plate 293 and the fifth wall part 205 in the liquid container 200. The coil spring 294 energizes the pressure receiving plate 293 from the fifth wall part 205 toward the sixth wall part 206. That is, the coil spring 294 energizes the sheet member 291 via the pressure receiving plate 293 in such a direction that the volume of the liquid container 200 is enlarged. The energizing force of the coil spring 294 keeps the pressure in the liquid container 200 lower than the atmospheric pressure (negative pressure).

In the present embodiment, the coil spring 294 is a cylindrical spring having uniform diameters of the circumference at a part close to the fifth wall part 205 and of the circumference at a part close to the sixth wall part 206, in a plan view along the direction from the fifth wall part 205 toward the sixth wall part 206. The shape of the coil spring 294 is not limited to such a shape, and the coil spring 294 may have different diameters of the circumference at a part close to the fifth wall part 205 and of the circumference at a part close to the sixth wall part 206.

The air is introduced into the liquid container 200 through the ventilation port 290, the air chamber 241 and an air introduction port 47 at a predetermined timing. The air introduction port 47 is a communication hole for connecting the space (the liquid container 200) between the fifth wall part 205 and the sheet member 291 and the space (the air chamber 241) between the sixth wall part 206 and the sheet member 291. The cartridge 20 has an air valve 40 for opening and closing the air introduction port 47. The air valve 40 includes a valve seat 46, a valve member 44 and a coil spring 42. The valve member 44 is pressed against the valve seat 46 by the coil spring 42 to close the air introduction port 47 serving as a through hole formed in the valve seat 46. The valve member 44 includes a valve part 43 capable of opening and closing the air introduction port 47, and a lever part 49 for moving the valve part 43 upon coming into contact with the pressure receiving plate 293.

The operation of the cartridge 20 is described below. In the initial state (unused state) of the cartridge 20, the liquid container 200 is filled with ink. At this time, as shown in FIG. 15, the pressure receiving plate 293 is located closest to the lid member 23.

As shown in FIG. 16, as the ink in the liquid container 200 is consumed and the pressure receiving plate 293 moves closer to the side of the fifth wall part 205, the pressure receiving plate 293 pushes the lever part 49 toward the side of the fifth wall part 205. As a result, the valve part 43 is released from the air introduction port 47. That is, the valve member 44 is turned to be in a valve opening state. Then, the outside air flows into the liquid container 200 through the ventilation port 290, the air chamber 241, and the air introduction port 47. As a result, as shown in FIG. 17, the volume of the liquid container 200 is increased by the amount of the air introduced. At the same time, the negative pressure in the liquid container 200 lowers close to the atmospheric pressure. When a certain amount of the air is introduced into the liquid container 200, the pressure receiving plate 293 is released from the lever part 49. As a result, the valve part 43 closes the air introduction port 47 again. That is, the valve member 44 is turned to be in a valve closing state. As described above, when the negative pressure in the liquid container 200 increases as the ink in the liquid container 200 is consumed, the valve member 44 is temporarily turned to be in the valve opening state, thereby enabling to keep the pressure in the liquid container 200 in an appropriate pressure range. This enables to suppress the ink from not being supplied from the liquid supply part 280 because the negative pressure in the liquid container 200 becomes too large, as an example.

FIG. 18 is an exploded perspective view of the cartridge 20. The cartridge 20 includes the body member 21, the lid member 23 having a plate shape, and the sheet member 291 having flexibility. The body member 21 has a substantially rectangular parallelepiped shape. The body member 21 has a recessed shape having an opening 222 in the +Y-axis direction side. The sheet member 291 is adhered or welded to the body member 21, and the sheet member 291 and the body member 21 partition the liquid container 200. That is, a part of the outer peripheral wall of the liquid container 200 is formed by the sheet member 291. The sheet member 291 has a through hole 292 formed so as to connect the air chamber 241 and the air introduction port 47.

The lid member 23 is attached to the body member 21 so as to cover the sheet member 291. The body member 21 and the lid member 23 are formed of a synthetic resin such as polypropylene. The sheet member 291 is formed of a synthetic resin such as material including nylon and polypropylene.

The pressure receiving plate 293 is formed of a synthetic resin such as polypropylene or metal such as stainless steel. The pressure receiving plate 293 is disposed in contact with the sheet member 291. The coil spring 294 is disposed in the liquid container 200. The coil spring 294 is in contact with the pressure receiving plate 293 and the opposed surface of the body member 21 to the pressure receiving plate 293. The pressure receiving plate 293 moves inside the liquid container 200 as the ink in the liquid container 200 is consumed. The pressure receiving plate 293 moves in the direction along the Y-axis direction.

The air valve 40 includes the coil spring 42, the valve member 44 and the valve seat 46. The valve seat 46 is attached to the body member 21 so as to be stored in a corner part 240 of the body member 21, at which the second wall part 202 and the fourth wall part 204 intersect with each other. The valve seat 46 is formed of, for example, a synthetic resin such as polypropylene. The valve seat 46 has a dent part, and the sheet member 291 is airtightly stuck on an end surface 41 having an opening of the dent part. The dent part of the valve seat 46 communicates with the through hole 292 of the sheet member 291. The air introduction port 47 is formed at the bottom of the dent part of the valve seat 46, so as to penetrate to the back side of the valve seat 46.

The valve part 43 of the valve member 44 is pressed against the valve seat 46 by the coil spring 42 to close the air introduction port 47. The pressure receiving plate 293 comes into contact with the lever part 49 of the valve member 44 through displacement of the pressure receiving plate 293. The valve member 44 is formed of, for example, a synthetic resin such as polypropylene. Alternatively, the valve member 44 may be formed by two-color molding using an elastic member such as elastomer and a synthetic resin such as polypropylene.

A label 25 may be stuck on the outer surface of the second wall part 202 of the body member 21 in some cases. The label 25 indicates, for example, a manufacturer and/or a model number of the cartridge 20. It is noted that the label 25 may be stuck at any position. In an example, the label 25 may be stuck on any one of the second wall part 202, the third wall part 203, the fourth wall part 204, the fifth wall part 205, and the sixth wall part 206, or may be stuck across two or more wall parts. Alternatively, a plurality of labels may be stuck on the plurality of wall parts.

As shown in FIG. 12, in the present embodiment, a distance L3 between the third wall part 203 and the fourth wall part 204 is longer than a distance L6 between the fifth wall part 205 and the sixth wall part 206. That is, the length of the cartridge 20 in the direction (X-axis direction) of the carriage 520 moving is longer than the length of the cartridge 20 in the direction (Y-axis direction) orthogonal to the direction of the carriage 520 moving. In a plan view from the first wall part 201 toward the second wall part 202, that is, when the cartridge 20 is viewed as shown in FIG. 12, a length L1 of the outer peripheral wall 288 in a first direction (X-axis direction) from the third wall part 203 toward the fourth wall part 204 is longer than a length L2 of the outer peripheral wall 288 in a second direction (Y-axis direction) from the fifth wall part 205 to the sixth wall part 206. That is, the length of the outer peripheral wall 288 in the direction (X-axis direction) of the carriage 520 moving is longer than the length of the outer peripheral wall 288 in the direction (Y-axis direction) orthogonal to the direction of the carriage moving. In the present embodiment, the length L1 is set within a range from 1.5 times to 2.0 times the length L2. In another embodiment, the length L1 may not be set within this range. In the present embodiment, in the state in which the cartridge 20 is mounted on the carriage 520, the first direction (X-axis direction) is set along the moving direction of the carriage. In the present embodiment, since the length L1 is longer than the length L2 and the direction of the length L1 is set along the moving direction of the carriage 520 as described above, a larger frictional force of the outer peripheral wall 288 may be generated against the sealing member 648 when the carriage 520 moves. This enables to suppress shifting between the liquid supply part 280 and the liquid introduction part 640 as the carriage 520 moves. Accordingly, the liquid supply part 280 and the liquid introduction part 640 are enabled to be connected properly.

In the present embodiment, in the plan view from the first wall part 201 toward the second wall part 202, that is, when the cartridge 20 is viewed as shown in FIG. 12, the distance from the third wall part 203 to the fourth wall part 204 is referred to as the distance L3, and the distance from the first wall part 201 to the fourth wall part 204 is referred to as a distance L4, wherein these values satisfy the following relation (1).

L1×2>(L3−L4) (1)

That is, in the present embodiment, the length L1 of the outer peripheral wall 288 along the X-axis direction is longer than half the length (L3−L4) of the first wall part 201 along the X-axis direction.

The liquid supply system 10 of the present embodiment is a so-called surface contact type in which the liquid supply part 280 of the cartridge 20 and the liquid introduction part 640 of the printer 50 come into contact with each other. Therefore, in order that the cartridge 20 is mounted on the carriage 520 without any air bubble being generated between the liquid supply part 280 and the liquid introduction part 640, the cartridge 20 is mounted on the carriage 520 preferably while being turned centering on a predetermined portion of an end wall of the cartridge 20. In the present embodiment, operation in the locus of mounting the cartridge 20 (refer to FIG. 13) includes the steps of bringing (while inclining) the end part of the cartridge-side filter 36 of the liquid supply part 280 into contact with the end part of the device-side filter 643 of the liquid introduction part 640, gradually changing the inclination to be horizontal, and finally bringing the both into surface contact with each other. This operation enables to push air bubbles sandwiched between the filters outward. In the liquid supply system 10 of the present embodiment, the substrate 15 is disposed on the inclined wall 207 positioned between the other end wall 204 and the bottom wall 201, in order to control the wiping area to be appropriate, in which the terminals disposed on the surface of the substrate 15 and the electrode parts 61 of the printer are rubbed with each other. Therefore, in the plan view of the cartridge 20 as viewed from the first wall part 201 toward the second wall part 202, the inclined wall 207 is required to be disposed as the area in which the substrate 15 is disposed, and thus such a disposition limits the area in which the outer peripheral wall 288 is disposed so as to surround the liquid supply part 280. Accordingly, when the length L1 of the outer peripheral wall 288 is defined as in the above-described relation (1), the area occupied by the outer peripheral wall 288 is enabled to be enlarged in the area excluding the inclined wall 207, thereby enabling to increase the frictional force of the outer peripheral wall 288.

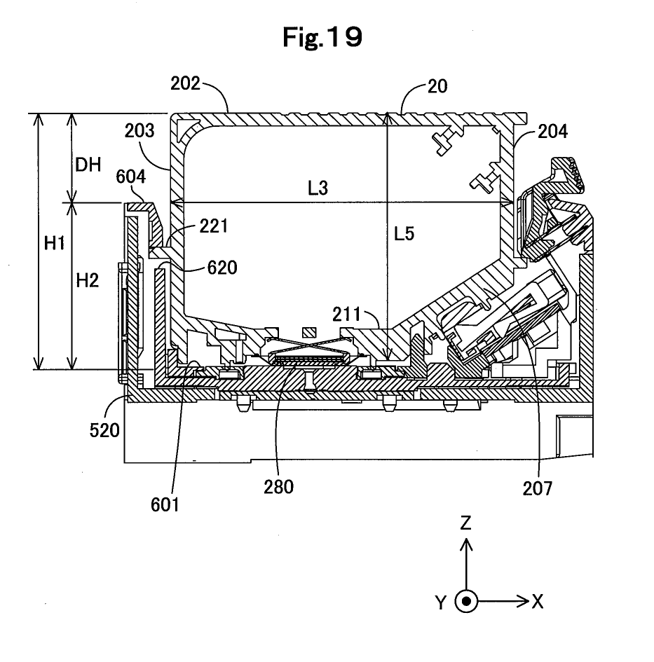

FIG. 19 is an XZ cross sectional view of the cartridge 20 and the carriage 520 in the mounted state. In the present embodiment, in the mounted state, H1 represents the distance from the bottom wall 601 of the carriage 520 (more specifically, the holder 60) to the second wall part 202 in the direction (Z-axis direction) from the first wall part 201 toward the second wall part 202, while 112 represents the height from the bottom wall 601 of the carriage 520, of the opposed part (side wall 604) of the wall parts of the carriage 520 to the third wall part 203 of the cartridge 20 in the direction (Z-axis direction) from the first wall part 201 toward the second wall part 202, wherein the following relation (2) is satisfied.

H1>H2 (2)

In other words, in the present embodiment, in the mounted state, the height H1 of the third wall part (end wall) 203 (on which the protrusion 221 is formed) of the wall parts of the cartridge 20 from the bottom wall 601 of the carriage 520 is larger than the height 112 of the side wall 604 (on which the dent part 620 is formed) of the wall parts of the carriage 520 from the bottom wall 601 of the carriage 520.

If the height 112 of the side wall 604 of the carriage 520 is set larger than the distance H1 from the bottom wall 201 of the cartridge 20 to the upper wall 202, the third wall part 203 of the cartridge 20 comes into contact with the side wall 604 of the carriage 520 at a higher position when the cartridge 20 is rotated to be mounted, and thus the radius of such rotation becomes larger. Therefore, the width of the carriage 520 in the moving direction may increase. In the present embodiment, the distance H1 from the bottom wall 201 of the cartridge 20 to the upper wall 202 is larger than the height 112 of the side wall 604 of the carriage 520 as in the relation (2), and thus the radius of such rotation is enabled to be reduced. Accordingly, the carriage 520 is enabled to be suppressed from being enlarged in the moving direction of the carriage 520.

Furthermore, in the present embodiment, DH represents the difference between the distance H1 and the height 112 in the mounted state, wherein the following relation (3) is satisfied.

DH×2>(H1−DH) (3)

That is, in the present embodiment, the height H1 of the third wall part (end wall) 203 having the protrusion 221 of the wall parts of the cartridge 20 from the bottom wall 601 of the carriage 520 is smaller than three times the difference DH between the height H2 of the third wall part 203 having the protrusion 221 of the wall parts of the cartridge 20 from the bottom wall 601 of the carriage 520 and the height H1 of the side wall 604 having the dent part 620 of the wall parts of the carriage 520 from the bottom wall 601 of the carriage 520. According to such a relation between the distance H1 and the difference DH, the carriage 520 is enabled to be suitably suppressed from being enlarged in the moving direction of the carriage 520.

In the present embodiment, L5 represents the distance from the first wall part 201 to the second wall part 202, while L3 represents the distance from the third wall part 203 to the fourth wall part 204, wherein the following relation (4) is satisfied.

L5×1.5>L3 (4)

Conventionally, a cartridge has been mounted on a carriage along the Y-axis direction in FIG. 1, in general. In such a configuration, if the mounting direction of the cartridge is simply rotated by 90 degrees around the Z axis as in the present embodiment, the width of the carriage may increase in the moving direction of the carriage. As the width of the carriage increases, the size of the space (home position) may also increase, in which the carriage stays when a printer is not operating. As a result, the size of the printer may be enlarged in the width direction (moving direction of the carriage). Therefore, the distance between the one end wall 203 and the other end wall 204 of the cartridge 20 is shortened compared with the conventional one, and the distance L5 from the bottom wall 201 to the upper wall 202 of the cartridge 20 is increased compared with the conventional one, thereby enabling to suppress the size of the printer 50 from being enlarged in the width direction (moving direction of the carriage 520). In the present embodiment, the distance L5 from the first wall part 201 to the second wall part 202 and the distance L3 from the third wall part 203 to the fourth wall part 204 are set so as to satisfy the above-described relation (4). Accordingly, the present embodiment enables to downsize the carriage 520 and the printer 50.

### B. Second Embodiment

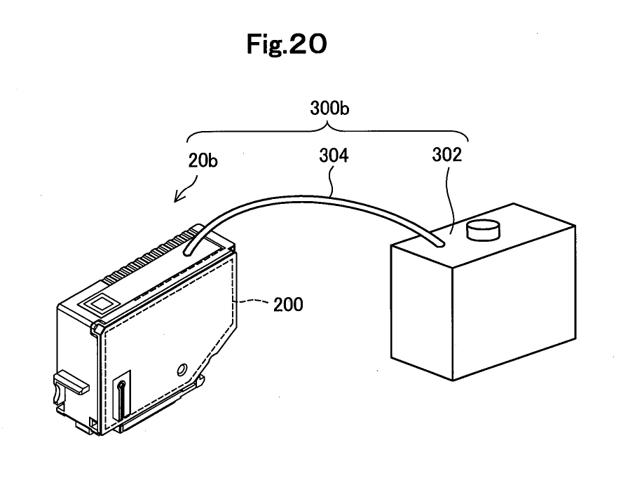

FIG. 20 is a schematic diagram illustrating a configuration of a liquid supply unit 300b in a second embodiment. In the second embodiment, the liquid supply unit 300b includes a cartridge 20b, a bottle 302 and a liquid supply tube 304. The cartridge 20b has the same structure as the cartridge 20 of the first embodiment except that the liquid supply tube 304 is connected.

The liquid supply tube 304 connects the bottle 302 and the liquid container 200 in the cartridge 20b. The bottle 302 contains ink. The bottle 302 is enabled to be replenished with ink as appropriate. The bottle 302 is disposed outside the printer 50. The ink in the bottle 302 is supplied to the liquid container 200 in the cartridge 20b through the liquid supply tube 304. Such a configuration of the liquid supply unit 300 as described above may be regarded as the configuration in which the liquid container 200 of the cartridge 20 in the first embodiment is enlarged externally. The above-described liquid supply unit 300b also has the same sizes of respective parts of the cartridge 20b as those in the first embodiment. Accordingly, the same action effects as those in the first embodiment are enabled to be exerted.

### C. Third Embodiment

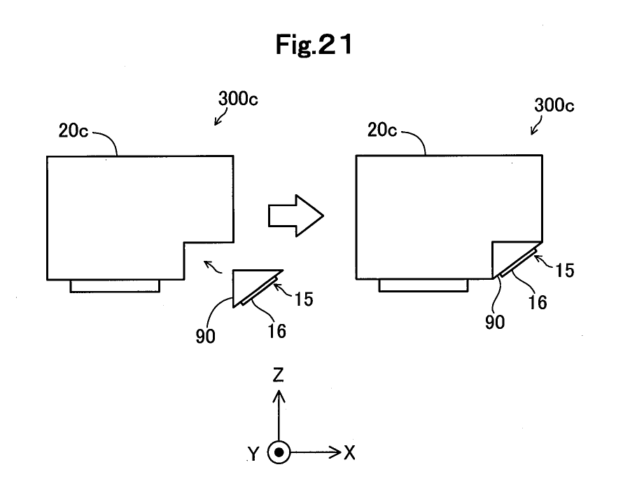

FIG. 21 is a schematic diagram illustrating a configuration of a liquid supply unit 300c in a third embodiment. The liquid supply unit 300c includes a cartridge 20c and a terminal part 90. The terminal part 90, which is a part separate from the cartridge 20c, is configured to be attachable to the cartridge 20c. The terminal part 90 includes the substrate 15. The substrate 15 includes the contact parts 16 coming into contact with the electrode part 61 of the printer 50. In the state in which the terminal part 90 is attached to the cartridge 20c, the apparent shape of the liquid supply unit 300c is substantially the same as that of the cartridge 20 of the first embodiment. Therefore, the liquid supply unit 300c is also capable of exerting the same action effects as those in the first embodiment. It is noted that the terminal part 90 may have any shape as long as the contact parts 16 are contactable with the electrode part 61 of the printer 50 in the state in which the terminal part 90 is attached to the cartridge 20c. In the present embodiment, as shown in FIG. 21, the terminal part 90 is formed in a substantially triangular prism shape.

### D. Modifications

### First Modification

In the above-described embodiments, all of the above-described relations (1) to (4) are satisfied. Alternatively, only some of the relations (1) to (4) may be satisfied, or none of the relations (1) to (4) may be satisfied. In an example, the liquid supply system 10 in the above-described embodiments may not satisfy the relation (1). In an example, the liquid supply system 10 in the above-described embodiments may not satisfy the relation (2). In an example, the liquid supply system 10 in the above-described embodiments may not satisfy the relation (3). In an example, the liquid supply system 10 in the above-described embodiments may not satisfy the relation (4).

### Second Modification

In the above-described embodiments, each of the wall parts of the first wall part 201 to the seventh wall part 207 may be configured to have a shape including a dent and a protrusion, of a part facing outward or of a part facing inward, not necessarily having a flat shape, as long as the wall parts compose the cartridge 20. In an example, the first cartridge-side regulating part 210 may be disposed on or included in the fourth wall part 204 as a part of the dents and protrusions of the fourth wall part 204. The second cartridge-side regulating part 221 may be disposed on or included in the third wall part 203 as a part of the dents and protrusions of the third wall part 203. The outer peripheral wall 288 surrounding the liquid supply part 280 may be disposed on or included in the first wall part 201 as a part of the dents and protrusions of the first wall part 201.

### Third Modification

In the above-described embodiments, as shown in FIG. 14, the liquid supply part 280 includes the foam 34 and the plate spring 35. Alternatively, the liquid supply part 280 may have any structure as long as the liquid supply part 280 is capable of supplying ink from the liquid container 200 to the liquid introduction part 640 of the printer 50. In an example, either one of the foam 34 and the plate spring 35 may be omitted. All or some of the cartridge-side filter 36, the foam 34 and the plate spring 35 may be replaced with one or more forms.

### Fourth Modification

In the above-described embodiments, the cartridge 20 is configured with seven wall parts. Alternatively, the number of the wall parts composing the cartridge 20 is not limited to seven as long as a space in which ink is contained is formed therein. In an example, the cartridge 20 may be configured with six or less wall parts, or may be configured with eight or more wall parts. In another example, the cartridge 20 may be configured with one or more spherical or curved wall parts. In another example, the cartridge 20 may be configured with combination of a curved wall part and a plate-like wall part.

### Fifth Modification

The present invention is applicable to any liquid jetting device for consuming other liquids than ink and to any cartridge (liquid supply unit) used in such a liquid jetting device, not being limited to an ink jet printer or an ink cartridge thereof. In an example, the present invention is applicable as a cartridge used in various types of liquid jetting devices as follows.

(1) Image recording device such as facsimile apparatus

(2) Color material jetting device used in manufacturing color filter for image display device such as liquid crystal display

(3) Electrode material jetting device used in forming electrode of organic EL (Electro Luminescence) display, FED (Field Emission Display), etc.

(4) Liquid jetting device for jetting liquid containing bio-organic matter used in manufacturing biochip

(5) Sample jetting device as precision pipette

(6) Lubricating oil injection device

(7) Liquid resin injection device

(8) Liquid jetting device for jetting lubricating oil at pin point to precision machine such as watch or camera

(9) Liquid jetting device for jetting transparent liquid resin such as liquid-type ultraviolet curing resin onto substrate to form micro hemispherical lens (optical lens) or the like used for optical communication element or the like

(10) Liquid jetting device for jetting acidic or alkaline etching solution to etch substrate or the like

(11) Liquid jetting device having liquid consuming head for ejecting minute amount of any other droplet

The term “droplet” refers to a state of liquid ejected by a liquid jetting device, including a grain state, a teardrop state, and a thread-like hanging state. The term “liquid” herein may be any material to be consumed by a liquid jetting device. In an example, “liquid” may be any material of a substance in a liquid phase, including liquid-state material having a high or low viscosity, and liquid-state material such as sol, gel water, other inorganic solvent, organic solvent, solution, liquid resin, and liquid metal (metallic melt). The term “liquid” includes not only liquid as one state of a substance, but also matter in which particles of functional material composed of solids such as pigment or metallic particle are dissolved, dispersed or mixed in solvent. Representative examples of liquid include ink, liquid crystal or the like as explained in the above embodiments. The ink herein includes various types of liquid compositions such as general water-based ink and oil-based ink, gel ink, and hot melt ink.

The present invention is not limited to the above-described embodiments or modifications, and is enabled to be realized in various configurations without departing from the gist thereof. In an example, in order to solve some or all of the above-described problems, or in order to achieve some or all of the above-described effects, technical features of the embodiments and the modifications corresponding to the technical features in respective aspects described in Summary of Invention may be replaced or combined as appropriate. Such technical features may be deleted as appropriate, unless otherwise described as essential features in the present specification.

### REFERENCE SIGNS LIST

10 LIQUID SUPPLY SYSTEM
15 SUBSTRATE
16 CONTACT PART
18 MEMORY DEVICE
20, 20b, 20c CARTRIDGE
21 BODY MEMBER
22 ENCLOSURE
23 LID MEMBER
25 LABEL
30 POSITIONING PART
32 COMMUNICATION PORT
34 FOAM
35 PLATE SPRING
36 CARTRIDGE-SIDE FILTER
40 AIR VALVE
41 END SURFACE
42 COIL SPRING
43 VALVE PART
44 VALVE MEMBER
46 VALVE SEAT
47 AIR INTRODUCTION PORT
49 LEVER PART
50 PRINTER
60 HOLDER
61 ELECTRODE PART
80 LEVER
90 TERMINAL PART
200 LIQUID CONTAINER
201 FIRST WALL PART (BOTTOM WALL)
202 SECOND WALL PART (UPPER WALL)
203 THIRD WALL PART (ONE END WALL)
204 FOURTH WALL PART (OTHER END WALL)
205 FIFTH WALL PART (ONE SIDE WALL)
206 SIXTH WALL PART (OTHER SIDE WALL)
207 SEVENTH WALL PART (INCLINED WALL)
210 FIRST CARTRIDGE-SIDE REGULATING PART (ONE RIB)
221 SECOND CARTRIDGE-SIDE REGULATING PART (PROTRUSION, OTHER RIB)
222 OPENING
240 CORNER PART
241 AIR CHAMBER
277 OPENING
280 LIQUID SUPPLY PART
281 LIQUID SUPPLY PORT
288 OUTER PERIPHERAL WALL
289 END PART
290 VENTILATION PORT
291 SHEET MEMBER
292 THROUGH HOLE
293 PRESSURE RECEIVING PLATE
294 COIL SPRING
300b, 300c LIQUID SUPPLY UNIT
510 CONTROL PART
517 FLEXIBLE CABLE
520 CARRIAGE
540 LIQUID JETTING HEAD
601 WALL PART (BOTTOM WALL)
602 CARTRIDGE HOUSING CHAMBER
603-606 WALL PART
607 PARTITION WALL
610 POSITIONING PROTRUSION
620 DEVICE-SIDE REGULATING PART (DENT PART)
640 LIQUID INTRODUCTION PART
642 TIP PART
643 DEVICE-SIDE FILTER
645 BASE END PART
648 SEALING MEMBER
R1 FIRST ROW
R2 SECOND ROW

1. A liquid supply unit configured to be mounted on a carriage of a liquid jetting device so as to supply liquid to a liquid introduction part of the carriage, the liquid supply unit comprising:
a first wall part;
a second wall part opposed to the first wall part;
a third wall part intersecting with the first wall part and the second wall part;
a fourth wall part intersecting with the first wall part and the second wall part and being opposed to the third wall part;
a fifth wall part intersecting with the first wall part, the second wall part, the third wall part and the fourth wall part;
a sixth wall part intersecting with the first wall part, the second wall part, the third wall part and the fourth wall part, and being opposed to the fifth wall part; and
a seventh wall part intersecting with the fifth wall part and the sixth wall part, and being positioned between the first wall part and the fourth wall part, wherein
the first wall part includes a liquid supply part and an outer peripheral wall surrounding the liquid supply part and protruding in a direction from the second wall part toward the first wall part so as to come into contact with a sealing member of the carriage,
the liquid supply part has a filter for supplying the liquid to the liquid introduction part upon coming into contact with the liquid introduction part,
a distance between the third wall part and the fourth wall part is larger than a distance between the fifth wall part and the sixth wall part,
in a plan view in a direction from the first wall part toward the second wall part, a length L1 of the outer peripheral wall in a first direction from the third wall part toward the fourth wall part is larger than a length L2 in a second direction from the fifth wall part toward the sixth wall part, and
in a state of the liquid supply unit mounted on the carriage, the first direction is set along a moving direction of the carriage.

2. The liquid supply unit according to claim 1, wherein
the third wall part has a protrusion protruding in a direction from the fourth wall part toward the third wall part so as to be engaged with a dent part of the carriage,
the liquid supply unit is configured to be rotated centering on a portion of the protrusion coming into contact with the dent part of the carriage when the liquid supply unit is mounted on and detached from the carriage, and
in the plan view in the direction from the first wall part toward the second wall part, L1 represents the length of the outer peripheral wall in the first direction, L3 represents a distance from the third wall part to the fourth wall part, and L4 represents a distance from the first wall part to the fourth wall part, wherein
relation of L1×2>(L3−L4) is satisfied.

3. The liquid supply unit according to claim 2, wherein
the seventh wall part has a contact part coming into contact with an electrode part of the liquid jetting device.

4. The liquid supply unit according to claim 2, wherein
in a state of the liquid supply unit mounted on the carriage,
H1 represents a distance from the bottom wall of the carriage to the second wall part in the direction from the first wall part toward the second wall part, while H2 represents a height from the bottom wall of the carriage, of an opposed part of wall parts of the carriage to the third wall part in the direction from the first wall part toward the second wall part, wherein
relation of H1>H2 is satisfied.

5. The liquid supply unit according to claim 2, wherein
in the state of the liquid supply unit mounted on the carriage,
H1 represents the distance from the bottom wall of the carriage to the second wall part in the direction from the first wall part toward the second wall part, while DH represents a difference between the distance H1 and a height from the bottom wall of the carriage, of the opposed part of the wall parts of the carriage to the third wall part in the direction from the first wall part toward the second wall part, wherein
relation of DH×2>(H1−DH) is satisfied.

6. The liquid supply unit according to claim 1, wherein
L5 represents a distance from the first wall part to the second wall part, while L3 represents a distance from the third wall part to the fourth wall part, wherein
relation of L5×1.5>L3 is satisfied.

7. A liquid jetting device comprising:
a carriage; and
a liquid supply unit mounted on the carriage, wherein
the carriage includes:
a liquid introduction part;
a sealing member surrounding the liquid introduction part; and
a liquid jetting head communicating with the liquid introduction part,
the liquid supply unit includes:
a liquid supply part coming into contact with the liquid introduction part; and
an outer peripheral wall surrounding the liquid supply part and protruding in a direction of the liquid supply part coming into contact with the liquid introduction part so as to come into contact with the sealing member,
the liquid supply part has a filter for supplying liquid to the liquid introduction part upon coming into contact with the liquid introduction part,
a length of the liquid supply unit in a direction of the carriage moving is larger than a length of the liquid supply unit in a direction orthogonal to the direction of the carriage moving, and
a length of the outer peripheral wall in the direction of the carriage moving is larger than a length of the outer peripheral wall in the direction orthogonal to the direction of the carriage moving.

8. The liquid jetting device according to claim 7, wherein
the carriage further includes a dent part,
the liquid supply unit further includes a protrusion to be engaged with the dent part,
the liquid supply unit is configured to be rotated centering on a portion of the protrusion coming into contact with the dent part of the carriage when the liquid supply unit is mounted on and detached from the carriage, and
a height of an end wall having the protrusion of wall parts of the liquid supply unit from a bottom wall of the carriage is larger than a height of a side wall having the dent part of wall parts of the carriage from the bottom wall of the carriage.

9. The liquid jetting device according to claim 7,
the carriage further includes a dent part,
the liquid supply unit further includes a protrusion to be engaged with the dent part,
the liquid supply unit is configured to be rotated centering on a portion of the protrusion coming into contact with the dent part of the carriage when the liquid supply unit is mounted on and detached from the carriage, and
a height of an end wall having the protrusion of wall parts of the liquid supply unit from a bottom wall of the carriage is smaller than three times a difference between the height of the end wall having the protrusion of the wall parts of the liquid supply unit from the bottom wall of the carriage and a height of a side wall having the dent part of wall parts of the carriage from the bottom wall of the carriage.

10. A liquid jetting device comprising:
a carriage;
a first liquid supply unit mounted on the carriage; and
a second liquid supply unit mounted on the carriage, wherein
the carriage includes:
a first liquid introduction part;
a second liquid introduction part;
a first sealing member surrounding the first liquid introduction part;
a second sealing member surrounding the second liquid introduction part; and
a liquid jetting head communicating with the first liquid introduction part and the second liquid introduction part,
the first liquid supply unit includes:
a first liquid supply part coming into contact with the first liquid introduction part; and
a first outer peripheral wall surrounding the first liquid supply part and protruding in a direction of the first liquid supply part coming into contact with the first liquid introduction part so as to come into contact with the first sealing member,
the second liquid supply unit includes:
a second liquid supply part coming into contact with the second liquid introduction part; and
a second outer peripheral wall surrounding the second liquid supply part and protruding in a direction of the second liquid supply part coming into contact with the second liquid introduction part so as to come into contact with the second sealing member,
the first liquid supply part has a first filter for supplying first liquid to the first liquid introduction part upon coming into contact with the first liquid introduction part,
the second liquid supply part has a second filter for supplying second liquid to the second liquid introduction part upon coming into contact with the second liquid introduction part,
a length of the first outer peripheral wall in a direction of the carriage moving is larger than a length of the first outer peripheral wall in a direction orthogonal to the direction of the carriage moving,
a length of the second outer peripheral wall in the direction of the carriage moving is larger than a length of the second outer peripheral wall in the direction orthogonal to the direction of the carriage moving, and
the first liquid supply unit and the second liquid supply unit are aligned in the carriage in the direction orthogonal to the direction of the carriage moving.

11. The liquid jetting device according to claim 10, wherein
the carriage further includes:
a first dent part; and
a second dent part,
the first liquid supply unit further includes
a first protrusion to be engaged with the first dent part,
the second liquid supply unit further includes
a second protrusion to be engaged with the second dent part,
the first liquid supply unit is configured to be rotated centering on a portion of the first protrusion coming into contact with the first dent part of the carriage when the first liquid supply unit is mounted on and detached from the carriage,
the second liquid supply unit is configured to be rotated centering on a portion of the second protrusion coming into contact with the second dent part of the carriage when the second liquid supply unit is mounted on and detached from the carriage,
a height of an end wall having the first protrusion of wall parts of the first liquid supply unit from a bottom wall of the carriage is larger than a height of a side wall having the first dent part of wall parts of the carriage from the bottom wall of the carriage, and
a height of an end wall having the second protrusion of wall parts of the second liquid supply unit from the bottom wall of the carriage is larger than a height of a side wall having the second dent part of the wall parts of the carriage from the bottom wall of the carriage.

12. A liquid jetting device comprising:
a carriage equipped with a first liquid supply unit and a second liquid supply unit, wherein
the carriage includes:
a first liquid introduction part;
a second liquid introduction part;
a first sealing member surrounding the first liquid introduction part;
a second sealing member surrounding the second liquid introduction part; and
a liquid jetting head communicating with the first liquid introduction part and the second liquid introduction part,
the first liquid supply unit includes:
a first liquid supply part coming into contact with the first liquid introduction part; and
a first outer peripheral wall surrounding the first liquid supply part and protruding in a direction of the first liquid supply part coming into contact with the first liquid introduction part so as to come into contact with the first sealing member,
the second liquid supply unit includes:
a second liquid supply part coming into contact with the second liquid introduction part; and
a second outer peripheral wall surrounding the second liquid supply part and protruding in a direction of the second liquid supply part coming into contact with the second liquid introduction part so as to come into contact with the second sealing member,
the first liquid supply part has a first filter for supplying first liquid to the first liquid introduction part upon coming into contact with the first liquid introduction part,
the second liquid supply part has a second filter for supplying second liquid to the second liquid introduction part upon coming into contact with the second liquid introduction part,
a length of the first outer peripheral wall in a direction of the carriage moving is larger than a length of the first outer peripheral wall in a direction orthogonal to the direction of the carriage moving,
a length of the second outer peripheral wall in the direction of the carriage moving is larger than a length of the second outer peripheral wall in the direction orthogonal to the direction of the carriage moving, and
the first liquid supply unit and the second liquid supply unit are aligned in the carriage in the direction orthogonal to the direction of the carriage moving.
